(19) United States
(12) Patent Application Publication
(10) Pub. No.: US 2018/0192453 A1
(43) Pub. Date: Jul. 5, 2018

(54) COMMUNICATION SYSTEM, COMMUNICATION METHOD, AND RECORDING MEDIUM IN WHICH COMMUNICATION PROGRAM IS RECORDED

(71) Applicant: NEC Corporation, Minato-ku, Tokyo (JP)

(72) Inventors: Yoshiaki NISHIKAWA, Tokyo (JP); Kosei KOBAYASHI, Tokyo (JP)

(73) Assignee: NEC Corporation, Minato-ku, Tokyo (JP)

(21) Appl. No.: 15/740,142

(22) PCT Filed: Jul. 26, 2016
(86) PCT No.: PCT/JP2016/003211

§ 371 Date: Dec. 27, 2017

(30) Foreign Application Priority Data
Jul. 10, 2015 (JP) 2015-138638

(51) Int. Cl. H04W 76/10; H04W 28/22; H04W 28/04

(52) U.S. Cl. CPC H04W 76/10; H04W 76/36; H04W 28/04; H04W 28/22

(57) ABSTRACT

To provide a communication system in which, when a wireless link between a reception-side device and a base station is in a state in which communication is possible, communication between a transmission-side device and the reception-side device is quickly reopened and packets can be appropriately transmitted and received. A communication system 10 is provided with a transmission-side device 20 and a relay communication device 31. The transmission-side device 20 includes a transmission unit 21 for transmitting data to a reception-side device. The communication device 31 includes a connection notification unit 33, and transmits and receives data between the transmission-side device 20 and the reception-side device. When a connection request is received from the reception-side device, the connection notification unit 33 transmits a connection notification to the transmission-side device 20.

### TECHNICAL FIELD

The present invention relates to a communication system, a communication method, and a storage medium having a communication program stored thereon, with respect to communication for transmitting/receiving packets.

### BACKGROUND ART

The communication via a communication network, such as the Internet, uses communication methods in which a transmission quantity is limited to prevent the congestion of the communication network. For example, TCP (Transmission Control Protocol), which is generally used in the communication between a Web server and web client terminals, limits the transmission quantity on the basis of a simultaneously transmittable data quantity that is called a window.

Specifically, a transmitting side apparatus halts its transmission when having transmitted packets whose data quantity is equivalent to the data quantity of the window (which is called a window size) to receiving side apparatuses. Each of the receiving side apparatuses transmits an acknowledgment (ACK) packet for responding to received packets to the transmitting side apparatus. Then, it is assumed that, in the transmitting side apparatus, upon reception of the ACK packet, a new space arises in the window. As a result, the transmitting side apparatus becomes capable of newly transmitting packets whose data quantity corresponds to the space.

Mobile communication networks as typified by a mobile phone communication network are widely used as access routes to the Internet. In such a mobile communication network in a cellular system, service areas are widely formed by placing a plurality of base stations in a distributed manner.

In an area surrounding each of the base stations, formed are radio cells that are ranges within which mobile communication terminals are communicable with the base station. In general, one base station is configured to form one to approximately six radio cells. In the mobile communication network in the cellular system, partial areas of adjacent radio cells are configured to overlap with each other. With such a configuration, the mobile communication network in the cellular system is configured to, even when a mobile communication terminal moves across a plurality of radio cells, enable the communication by the mobile communication terminal to be continued by means of a handover (HO) function.

PTL 1 describes a method in which a receiving side apparatus is provided with a retransmission timer (ACK retransmission timer) for ACK packets transmitted by the apparatus itself.

PTL 2 describes an apparatus that, before the coming of RTT (Round Trip Time) that is a predetermined timing at which packets are retransmitted, transmits the packets.

PTL 3 describes a terminal that, upon reception of a connection request, sends back a connection request response in response to the connection request.

PTL 4 describes an apparatus that controls communication on the basis of the communication state between a base station and a mobile terminal.

PTL 5 describes a system in which, when a receiving side apparatus determines that reception errors have occurred, a transmitting side apparatus retransmits packets in response to a request by the receiving side apparatus.

PTL 6 describes a transmitting side apparatus that gives numbers in accordance with transmitting order to packets each having high priority, and transmits the packets.

### CITATION LIST

### Patent Literature

[PTL 1] Japanese Patent No. 5185955

[PTL 2] Japanese Unexamined Patent Application Publication No. 2010-98766

[PTL 3] Japanese Unexamined Patent Application Publication No. 2014-96659

[PTL 4] Japanese Unexamined Patent Application Publication No. 2002-281047

[PTL 5] Japanese Unexamined Patent Application Publication No. 2005-295190

[PTL 6] Japanese Unexamined Patent Application Publication No. 2007-116204

### SUMMARY OF INVENTION

### Technical Problem

In the mobile communication network, a bursty loss of packets transmitted from a transmitting side apparatus (a server) to a receiving side apparatus (a mobile communication terminal) sometimes occurs. Specifically, the loss of packets sometimes occurs in a case where, because of reasons such as the deterioration of a radio quality, a radio link failure (RLF) has occurred between a base station and the mobile communication terminal, and in any other similar case.

For example, even though a mobile communication terminal connects to the same base station before the disconnection of its radio link and after the reconnection of the radio link, a problem described below arises when the period of the disconnection of the radio link is long. That is, the base station may discard untransmitted packets which are received from a server or the like and whose destinations are the mobile communication terminal.

Further, in the case where a mobile communication terminal connects to the different base stations before the disconnection of its radio link and after the reconnection of the radio link, a problem described below arises. That is, a source base station may discard untransmitted packets which are received by itself and whose destinations are the mobile communication terminal without transmitting the untransmitted packets to a target base station. In this problem, the source base station is a base station where the mobile communication terminal has connected before disconnecting the radio link, and the target base station is a base station where the mobile communication terminal connects after reconnecting the radio link. The latter problem occurs particularly in the case where the handover of the mobile communication terminal is not normally executed.

In the case where such a packet loss has occurred when a transmitting side apparatus (a server) is transmitting packets to a receiving side apparatus (a mobile communication terminal) on the basis of the TCP, the packets being transmitted by the server is not received by the mobile communication terminal. Thus, any ACK packet from the mobile communication terminal is not received by the server, and a new space does not arise in the window of the TCP-based server. As a result, although the radio link between the mobile communication terminal and the base station is in a communicable state, the transmission of packets from the server to the mobile communication terminal is brought into a halt.

In the method described in PTL 1, the receiving side apparatus repeats the retransmission of the ACK packet at intervals of a period of time set in the retransmission timer. According to such a configuration, when the transmission of packets from the mobile communication terminal to the base station is enabled, and also the period of time set in the retransmission timer has elapsed, the mobile communication terminal is capable of transmitting the ACK packet. As a result, the halt of the transmission of packets in the transmitting side apparatus is released, and the transmitting side apparatus becomes capable of transmitting new packets.

For the method described in PTL 1, however, the period when the transmission is halted in the transmitting side apparatus depends on the period of time set in the ACK retransmission timer. Thus, the period when any packet is not transmitted may be continued for a long period.

That is, for the method described in PTL 1, even though the period when such a bursty packet loss occurs is terminated, the ACK packet is not transmitted from the receiving side apparatus during at most the period of time set in the ACK retransmission timer, and thus, as a result, the halt of the transmission of packets continues in the transmitting side apparatus.

The apparatus described in PTL 2 frequently retransmits packets, and thus, there occurs a problem in that the number and the data quantity of transmitted/received packets become large, and as a result, heavy loads are exerted on a communication line and packet transmission/reception processing.

For the terminal described in PTL 3 and the apparatus described in PTL 4, in the case where a bursty packet loss has occurred, the connection request cannot be received, and as a result, the halt of the transmission of packets by the terminal may continue.

For the system described in PTL 5, in the case where a bursty packet loss has occurred, a determination that the retransmission of the ACK packet is necessary is not made in the receiving side apparatus, and as a result, the halt of the transmission of packets may continue in the transmitting side apparatus.

For the transmitting side apparatus described in PTL 6, in the case where a bursty packet loss has occurred, the halt of the transmission is not released until the reception of an ACK packet from a receiving side apparatus. For this reason, the period when any packet is not transmitted may continue for a long period.

Thus, the present invention is intended to provide a communication system, a communication method, and a program for communication that are capable of, when the radio link between a receiving side apparatus and a base station has been restored to a communicable state, promptly resuming communication and appropriately transmitting/receiving packets between a transmitting side apparatus and the receiving side apparatus.

### Solution to Problem

A communication system according to the present invention includes: a transmitting side apparatus including transmitting means configured to transmit data to a receiving side apparatus; and a communication apparatus installed in a network to which the transmitting side apparatus and the receiving side apparatus are connectable, wherein the communication apparatus includes connection notifying means configured to, upon reception of a connection request from the receiving side apparatus, transmit a connection notification to the transmitting side apparatus, and wherein upon reception of the connection notification, the transmitting side apparatus allows the transmitting means to transmit data.

A communication method according to the present invention includes: upon reception of a connection request from a receiving side apparatus configured to receive data transmitted by a transmitting side apparatus, transmitting, to the transmitting side apparatus, a connection notification for allowing the transmitting side apparatus to transmit data.

A communication program according to the present invention allows a computer to execute processing including: a connection notification processing configured to, upon reception of a connection request from a receiving side apparatus configured to receive data transmitted by a transmitting side apparatus, transmit, to the transmitting side apparatus, a connection notification for allowing the transmitting side apparatus to transmit data.

A communication program according to another aspect of the present invention allows a computer to execute processing including: an acknowledgment relay processing configured to transmit an acknowledgment that is transmitted by a receiving side apparatus, the receiving side apparatus being configured to receive data transmitted by a transmitting side apparatus, the acknowledgement being an acknowledgment for the reception of the data by the receiving side apparatus; and a connection notification processing configured to, upon reception of a connection request from the receiving side apparatus, transmit, to the transmitting side apparatus, a connection notification for allowing already transmitted data to be retransmitted based on the acknowledgment received.

### Advantageous Effects of Invention

According to the present invention, when the radio link between a receiving side apparatus and a base station has been restored to a communicable state, communication between a transmitting side apparatus and the receiving side apparatus is promptly resumed, and packets can be appropriately transmitted/received.

### BRIEF DESCRIPTION OF DRAWINGS

FIG. 1 is a block diagram illustrating an example of the configuration of a communication system of a first example embodiment of the present invention.

FIG. 2 is a sequence diagram illustrating the operation of the communication system of the first example embodiment of the present invention.

FIG. 3 is an explanatory diagram illustrating an example of connection information.

FIG. 4 is a block diagram illustrating an example of the configuration of a communication system of a second example embodiment of the present invention.

FIG. 5 is a block diagram illustrating an example of the configuration of a communication system of a third example embodiment of the present invention.

### DESCRIPTION OF EMBODIMENTS

### Example Embodiment 1

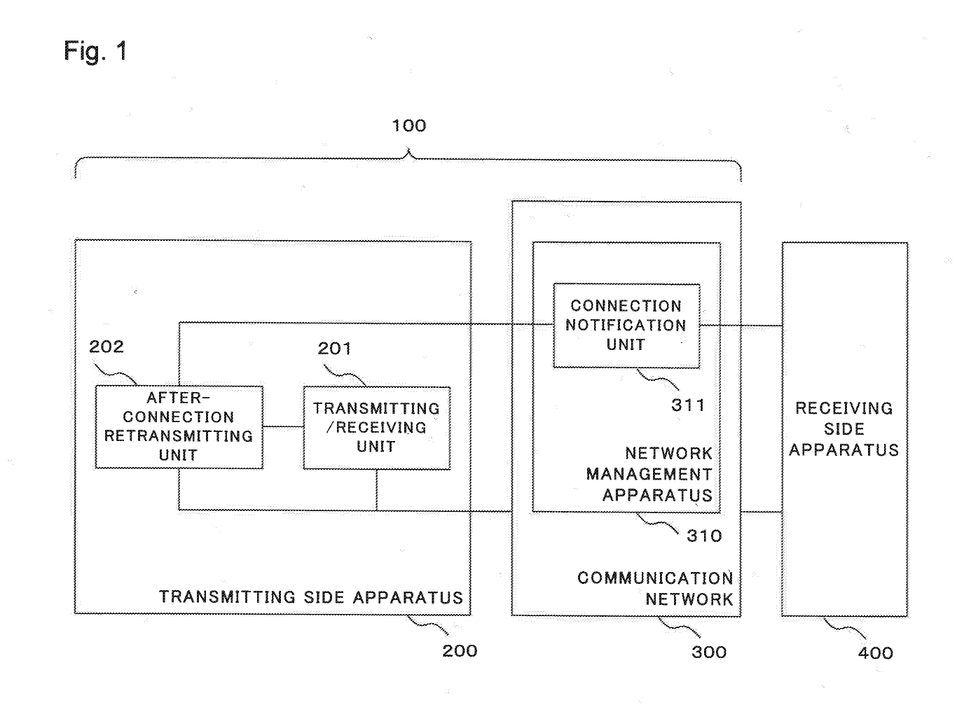

A communication system 100 of a first example embodiment of the present invention will be described with reference to the drawings. FIG. 1 is a block diagram illustrating an example of the configuration of the communication system 100 of the first example embodiment of the present invention. As shown in FIG. 1, the communication system 100 of the first example embodiment of the present invention includes a transmitting side apparatus 200 and a network management apparatus 310.

The network management apparatus 310 is installed on a communication network 300 to which the transmitting side apparatus 200 and a receiving side apparatus 400 are connected.

The communication network 300 is a communication network, such as a mobile phone communication network, that is based on a standard for any one of LTE (Long Term Evolution), LTE-Advanced, UMTS (Universal Mobile Telecommunications System), GSM (Global System for Mobile Communications) (registered trademark), WiMAX (Worldwide Interoperability for Microwave Access), CDMA (Code Division Multiple Access) 2000, HSPA (High Speed Packet Access), a wireless LAN (Local Area Network), and the like.

The network management apparatus 310 is, for example, an apparatus in which a CPU (Central Processing Unit) configured to execute processing in accordance with program control is mounted. Such apparatus is any one of a base station and a base station management apparatus (RNC: Radio Network Controller) for a mobile phone communication network; an MME (Mobility Management Entity) for LTE; an access point (AP: Access Point) for a wireless LAN; various kinds of gateways and relay devices that are installed within the communication network 300; and the like.

The transmitting side apparatus 200 is, for example a computer in which a CPU configured to execute processing in accordance with program control is mounted.

The receiving side apparatus 400 is, for example, an apparatus in which a CPU configured to execute processing in accordance with program control is mounted. Such apparatus is any one of mobile phones, such as a feature phone and a smart phone; a tablet terminal; a notebook type personal computer (Laptop Computer); various kinds of sensing devices; an M2M (Machine to Machine) device; and the like.

As shown in FIG. 1, the transmitting side apparatus 200 includes a transmitting/receiving unit 201 and an after-connection retransmitting unit 202.

The transmitting/receiving unit 201 transmits packets to the receiving side apparatus 400 via the communication network 300 within the range of the limited transmission quantity (for example, the window in the TCP). The transmitting/receiving unit 201 receives, via the communication network 300, ACK packets transmitted from the receiving side apparatus 400.

Upon reception of a connection notification having been transmitted to the transmitting side apparatus 200 by the network management apparatus 310, the after-connection retransmitting unit 202 identifies a receiving side apparatus 400 corresponding to the connection notification, and transmits packets to the identified receiving side apparatus 400. For example, the after-connection retransmitting unit 202 identifies a receiving side apparatus 400 corresponding to the connection notification, and retransmits, to the identified receiving side apparatus 400, packets having no delivery acknowledgment by ACK packets among packets already transmitted to the receiving side apparatus 400.

The receiving side apparatus 400 receives packets transmitted from the transmitting side apparatus 200 via the communications network 300, and transmits an acknowledgment (ACK) packet to the transmitting side apparatus 200. Further, the receiving side apparatus 400 makes a connection request for an establishment of a radio link to the network management apparatus 310. For example, in the case of a UMTS network and an LTE network, the radio link is also called an RRC (Radio Resource Control) connection, and is a communication link that is established by connecting a physical radio channel between a base station and a mobile communication terminal.

As shown in FIG. 1, the network management apparatus 310 includes a connection notification unit 311. Upon reception of the connection request, from the receiving side apparatus 400, for an establishment of a radio link, the connection notification unit 311 transmits, to the transmitting side apparatus 200, a connection notification including connection information of the receiving side apparatus 400. Note that the connection information will be described later. Additionally, the network management apparatus 310 is not always necessary to receive the connection request for an establishment of a radio link directly from the receiving side apparatus 400, and may receive it indirectly via other one or more relay apparatuses that are not illustrated in FIG. 1.

The connection notification unit 311 may transmit partial connection requests each satisfying a predetermined condition among connection requests each being for an establishment of a radio link and already received from the receiving side apparatus 400, to the transmitting side apparatus 200 as connection notifications. For example, the connection notification unit 311 transmits a connection request for which a probability that a packet loss has occurred immediately before the connection request is high to the transmitting side apparatus 200 as a connection notification. Specifically, the connection notification unit 311 transmits a connection notification to the transmitting side apparatus 200 in any one of the following cases.

1. In the case where, after a radio link of the receiving side apparatus 400 has been disconnected over a long period, a connection request for an establishment of the radio link has been received from the receiving side apparatus 400.

2. In the case where the connection request is a connection request for an establishment of a radio link to a base station B when the receiving side apparatus 400 has changed its connection destination from a base station A to the base station B, and because of the occurrence of a problem in the handover from the base station A to the base station B, packets already buffered in the base station A before the handover (packets that are not yet transmitted to the receiving side apparatus 400) have not been transferred to the base station B after the handover.

Next, the connection information, which is included in the connection notification to be transmitted to the transmitting side apparatus 200 by the connection notification unit 311, will be described. The “connection information of the receiving side apparatus 400” included in the connection notification transmitted by the connection notification unit 311 includes at least information that enables the transmitting side apparatus 200 to identify communication with the receiving side apparatus 400 having transmitted the connection request. The information that enables the transmitting side apparatus 200 to identify communication with the receiving side apparatus 400 having transmitted the connection request corresponds to, for example, identifiers of the receiving side apparatus 400, such as an IP (Internet Protocol) address, a port number, a connection ID, a MAC (Media Access Control) address, and a terminal identifier within the communications network 300 (used within the communication network 300).

In the case where, for the same receiving side apparatus 400, these identifiers are changed and a set of these identifiers before a connection request and another set of these identifiers after the connection request are different from each other, both of or only any one of the set of the identifiers before the change and the another set of the changed identifiers may be included in the connection information. Non-limiting examples of the terminal identifier within the communication network 300 include, in the case of LTE, S-TMSI (SAE (System Architecture Evolution)-Temporary Mobile Subscriber Identity), IMSI (International Mobile Subscriber Identity), RNTI (Radio Network Temporary Identifier), and GUTI (Global Unique Temporary Identifier). The connection information may further include, in addition to the terminal identifier within the communication network 300, an identifier of a radio cell to which a terminal (for example, the receiving side apparatus 400) is connected. The identifier of the radio cell corresponds to, for example, Cell Global Identity (CGI) and ECGI.

The connection notification unit 311 acquires these identifiers through packet analysis processing, such as DPI (Deep Packet Inspection); control messages transmitted by the receiving side apparatus 400; cooperation with any other unillustrated apparatus within the communication network 300; and/or the like. For example, the connection notification unit 311 is capable of acquiring information in relation to S-TMSI from ue (user equipment)-Identity included in an RRC Connection Request message that is one kind of the control messages.

The identifier included in the connection information may be any one identifier or any plural identifiers among the above-described identifiers. For example, the connection information may include both of the IP address and the terminal identifier within the communication network 300. According to such a configuration, even in the case where IP addresses of the receiving side apparatus 400 before and after the connection to a radio link are different from each other, the connection notification unit 311 is capable of identifying that the IP address before the connection and the IP address after the connection are IP addresses allocated to the same receiving side apparatus 400 on the basis of the terminal identifier within the communication network 300. Further, for example, the connection information may include both of the IP address and the port number. According to such a configuration, the transmitting side apparatus 200 is capable of identifying, not only the receiving side apparatus 400, but also the kind of application (for example, Web browsing, Video Streaming, VoIP, or the like) and the name of application software with respect to communication by the receiving side apparatus 400.

The above mentioned “connection information of the receiving side apparatus” included in the connection notification may include a date and a time at which the connection request is received from the receiving side apparatus 400; information indicating the result of processing on the connection request at the side of the communication network 300; and the like.

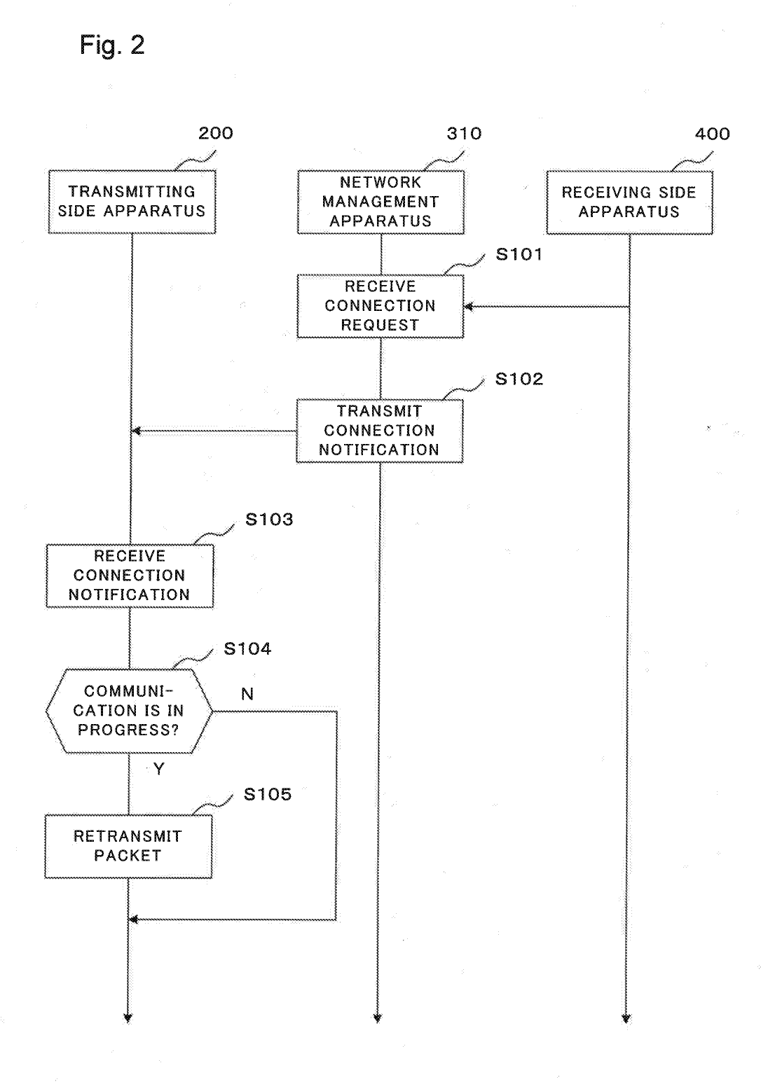

Next, the operation of the communication system 100 of the first example embodiment of the present invention will be described. FIG. 2 is a sequence diagram illustrating the operation of the communication system 100 of the first example embodiment of the present invention.

In the communication system 100 of the first example embodiment of the present invention, the connection notification unit 311 of the network management apparatus 310 receives a connection request having been transmitted by the receiving side apparatus 400 (step S101). The connection request includes, for example, information serving as connection information of the receiving side apparatus 400 and being sufficient for, in the transmitting side apparatus 200, identifying communication with the receiving side apparatus 400 having transmitted the connection request. Further, the connection request may include information indicating a transmitting side apparatus 200 that is the other communication party desired by the receiving side apparatus 400. The connection notification unit 311 transmits a connection notification to the transmitting side apparatus 200 (step S102).

The after-connection retransmitting unit 202 of the transmitting side apparatus 200 receives the connection notification transmitted in the processing of step S102 (step S103). Then, based on the received connection notification, the after-connection retransmitting unit 202 identifies communication with the receiving side apparatus 400 having transmitted the connection request, and determines whether or not the communication is in progress (step S104).

In the case where the communication is being continued (Y in step S104), the after-connection retransmitting unit 202 starts the retransmission of packets (step S105).

A specific example of a method for allowing the after-connection retransmitting unit 202 to identify communication with the receiving side apparatus 400 having transmitted the connection request, and determine whether or not the communication is being continued will be described. First, the after-connection retransmitting unit 202 identifies a receiving side apparatus 400 on the basis of the connection information included in the connection notification.

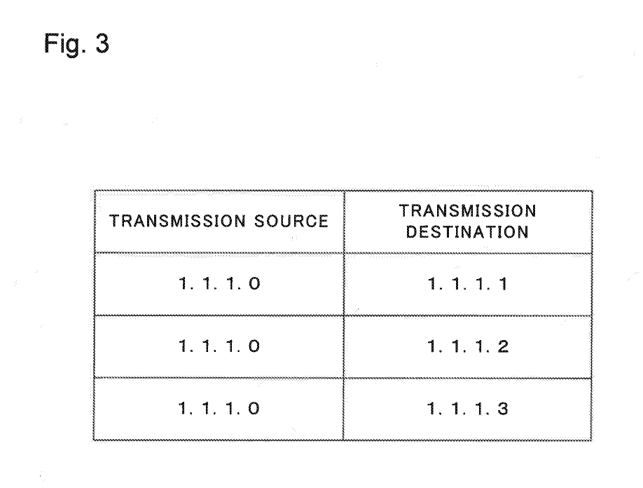

Next, the after-connection retransmitting unit 202 searches the destinations of communication being currently performed by the transmitting side apparatus 200 to search for communication with the receiving side apparatus 400 identified on the basis of the connection information. For example, the after-connection retransmitting unit 202 may have such a management table for currently performed communications as shown in FIG. 3. One example of the management table shown in FIG. 3 indicates that a transmitting side apparatus 200 whose IP address is 1. 1. 1. 0 is in communication with a receiving side apparatus 400 whose IP address is 1. 1. 1. 1. Another example shown in FIG. 3 indicates that a transmitting side apparatus 200 whose IP address is 1. 1. 1. 0 is in communication with a receiving side apparatus 400 whose IP address is 1. 1. 1. 2. Further, another example shown in FIG. 3 indicates that a transmitting side apparatus 200 whose IP address is 1. 1. 1. 0 is in communication with a receiving side apparatus 400 whose IP address is 1. 1. 1. 3.

At this time, in the case where it is identified by the connection information included in the connection notification that the IP address of a receiving side apparatus is 1. 1. 1. 2, the after-connection retransmitting unit 202 is capable of, by referring to the management table, determining that communication with the receiving side apparatus is being continued. On the other hand, in the case where it is identified by the connection information included in the connection notification that the IP address of a receiving side apparatus is 1. 1. 1. 20, the after-connection retransmitting unit 202 is capable of, by referring to the management table, determining that communication with the receiving side apparatus is not being continued.

Next, operation in the case where the retransmission of packets is performed will be described. The after-connection retransmitting unit 202 sequentially retransmits each of packets that are already transmitted, but are not yet acknowledged in the communication having been identified and determined as communication being continued, in order from a packet whose transmission timing is earliest. Alternatively, the after-connection retransmitting unit 202 may retransmit any packets obtained by, for example, a random selection from among packets that are not yet acknowledged, or may retransmit all of packets that are not yet transmitted. The after-connection retransmitting unit 202 may retransmit packets on the basis of any one of the methods described above, or may retransmit packets on the basis of any other method. Note that the retransmission in the present examples may include, in addition to transmitting already transmitted packets once again, operation for allowing such a transmission to be promptly executed. In the case where there exists any other relay apparatus having the function of controlling the transmission of packets, the after-connection retransmitting unit 202 may transmit, to such a relay apparatus, an instruction for allowing the transmission of packets to be promptly executed.

When retransmitting packets, the after-connection retransmitting unit 202 of the transmitting side apparatus 200 may add flag information indicating a prioritized transmission to packets to be retransmitted. A base station having received packets to which the flag information is added prioritizes the allocation of a radio resource to the packets. According to such a configuration, the timing at which the base station transmits the packets to the receiving side apparatus can be made earlier.

The after-connection retransmitting unit 202 is capable of notifying the flag information indicating the prioritized transmission using an unused field of TCP packet. As an unused area of an IP header, it is possible to use any one of fields included in an IP header (a header of IPv4 (Internet Protocol version 4) or the like), such as Reserved Bits of TOS (Type of Service) field, Reserved Bits of DS (Differentiated Service) field, Options field, and Padding field.

According to the present example embodiment, even in the case where the transmitting side apparatus 200 cannot receive the acknowledgment (ACK) packet from the receiving side apparatus 400, and cannot transmit any new packet because the transmission quantity has reached a limit (for example, the window size in the TCP) in the transmitting side apparatus 200, communication between the transmitting side apparatus 200 and the receiving side apparatus 400 can be resumed promptly after the radio link with the base station has been connected.

This reason is because the transmitting side apparatus 200 becomes capable of detecting a state in which the radio link between the receiving side apparatus 400 and the base station has been connected and the communication therebetween has been made available, and thus, the transmitting side apparatus 200 is capable of resuming the transmission of packets.

Further, since a general-purpose mobile communication terminal can be utilized as the receiving side apparatus 400, the present system can be introduced at low cost.

### Example Embodiment 2

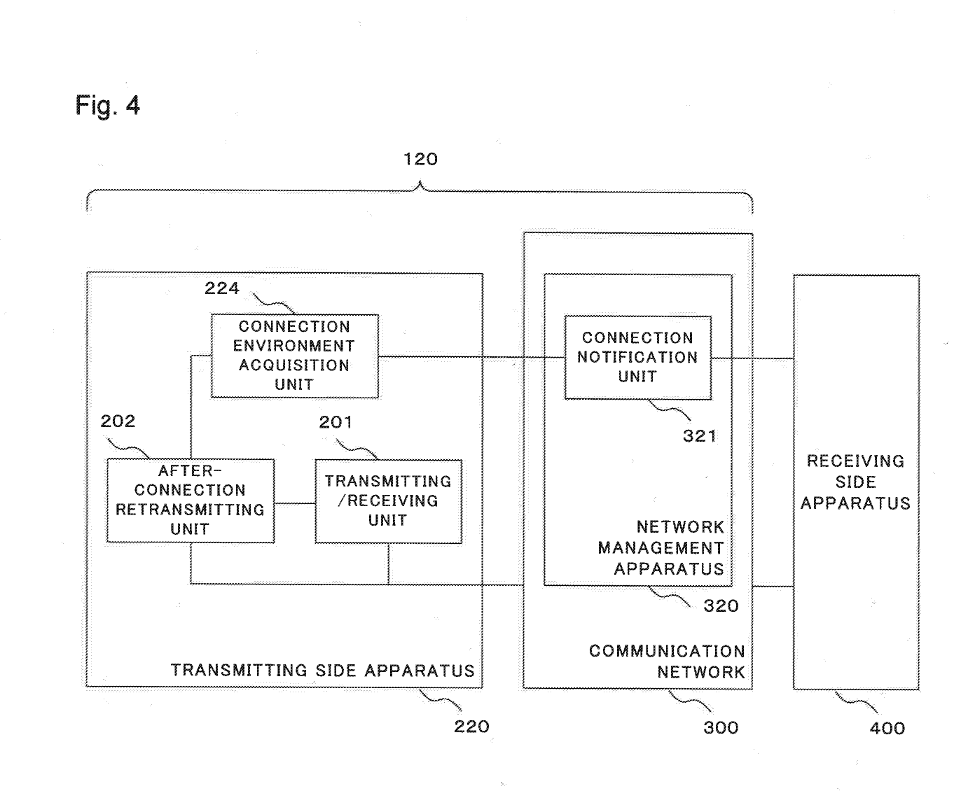

A communication system 120 of a second example embodiment of the present invention will be described with reference to the drawings. FIG. 4 is a block diagram illustrating an example of the configuration of the communication system 120 of the second example embodiment of the present invention. As shown in FIG. 4, the communication system 120 of the second example embodiment of the present invention is different from the communication system 100 of the first example embodiment, shown in FIG. 1, in that a network management apparatus 320 includes a connection notification unit 321, and a transmitting side apparatus 220 includes a connection environment acquisition unit 224. The other constituent elements in the communication system 120 of the second example embodiment of the present invention are the same as constituent elements in the communication system 100 of the first example embodiment, shown in FIG. 1, and thus, corresponding constituent elements will be denoted by the same reference signs as those in FIG. 1, and will be omitted from description.

The connection notification unit 321 of the network management apparatus 320 acquires connection environment information of a receiving side apparatus 400 having transmitted a connection request, and transmits a connection notification including the acquired connection environment information to the transmitting side apparatus 220. The connection environment information, however, is not necessarily included in the connection notification, and may be transmitted to the transmitting side apparatus 220 as a notification different from the connection notification. The connection environment information will be described later.

The connection environment acquisition unit 224 of the transmitting side apparatus 220 acquires the connection environment information from the connection notification unit 321. Then, the transmitting/receiving unit 201 and the after-connection retransmitting unit 202 of the transmitting side apparatus 220 refer to the connection environment information having been acquired by the connection environment acquisition unit 224, and controls the transmission quantity of packets accordingly.

The connection environment information will be described. The connection environment information is information indicating the communication quality of the radio link between the communication network 300 and the receiving side apparatus 400. Specifically, the effective bandwidth and the delay of the radio link, the congestion degree of a base station to which the receiving side apparatus 400 is connected, the radio quality of the receiving side apparatus 400, and the like can be used as the connection environment information, but the connection environment information is not limited to these.

The congestion degree of a base station is represented by, for example, a radio resource usage ratio, such as a Physical Resource Block (PRB) usage ratio or an electric power usage ratio; the number of receiving side apparatuses being connected to the base station (the number of connected terminals); the number of receiving side apparatuses which are among receiving side apparatuses being connected to the base station and in which not-yet-transmitted packets whose destinations are the receiving side apparatuses exist in the buffer of the base station itself (the number of simultaneously communicating terminals); or the like. Instead of the number of receiving side apparatuses, the number of bearers may be used.

The radio quality of the receiving side apparatus 400 includes, for example, received power in the receiving side apparatus 400, the ratio of the power of interference waves relative to the power of a desired wave, and the like. As the received power, for example, an index representing a reception intensity of a pilot signal, a reference signal, or the like for a radio cell targeted for the estimation of the radio quality is used. As the received power, for example, CPICH RSCP (Common Pilot Channel Received Signal Code Power) in UMTS, RSRP (Reference Signal Received Power) in LTE, or the like is used. Meanwhile, the ratio of the power of a desired wave to the power of interference waves is an index representing the ratio of the received power of a signal received from a target radio cell to the interference power, the thermal noise power, and the like. As the ratio of the power of a desired wave to the power of interference waves, for example, SINR (Signal to Interference plus Noise Ratio), SIR (Signal to Interference Ratio), CPICH Ec/No in UMTS, RSRQ (Reference Signal Received Quality) in LTE, or the like is used. The radio quality is not necessarily represented by a real number, but may be one of indexes obtained by quantizing numerical values into several levels. For example, the radio quality may be CQI (Channel Quality Indicator) in LTE, or the like.

The connection environment acquisition unit 224 of the transmitting side apparatus 220 may estimate an effective bandwidth of the radio link between the receiving side apparatus 400 and the base station on the basis of both of the congestion degree of the base station, indicated by the connection environment information acquired from the network management apparatus 320, and the radio quality of the receiving side apparatus 400.

For example, in the case of LTE, the connection environment acquisition unit 224 estimates MCS (Modulation and Coding Scheme) indicating a modulation scheme and an encoding scheme on the basis of CQI reported from the receiving side apparatus 400. The connection environment acquisition unit 224 estimates MCS corresponding to the reported CQI on the basis of, for example, a preliminarily prepared correspondence table between CQI and MCS.

Further, based on the congestion degree of the base station (for example, the number of simultaneously communicating terminals in the base station), the connection environment acquisition unit 224 estimates a physical resource block quantity expected to be allocated to the receiving side apparatus 400. For example, in the case where the number of simultaneously communicating terminals is N, the connection environment acquisition unit 224 estimates that, among a total of M physical resource blocks, M/N physical resource blocks are averagely allocated to one receiving side apparatus 400. Based on the estimated MCS and physical resource block quantity, the connection environment acquisition unit 224 estimates a transport block size (TBS) that can be transmitted to the receiving side apparatus 400 via the radio link. Then, the connection environment acquisition unit 224 determines the estimated transport block size as the effective bandwidth.

Instead of the configuration in which the transmitting side apparatus 220 estimates the effective bandwidth of the radio link between the receiving side apparatus 400 and the base station, the network management apparatus 320 may be configured to estimate the effective bandwidth. In that case, the connection environment acquisition unit 224 of the transmitting side apparatus 220 receives the effective bandwidth having been estimated by the network management apparatus 320 as the connection environment information.

Based on the connection environment information, the transmitting/receiving unit 201 and the after-connection retransmitting unit 202 of the transmitting side apparatus 220 control the adjustment of a transmission rate; the adjustment of a quantity of data that can be transmitted without receiving any acknowledgment (a window size); an increase (growth) speed of the quantity of data that can be transmitted without receiving any acknowledgment (the window size), and the change of the state of a communication connection; and the like. Specifically, the transmitting/receiving unit 201 and the after-connection retransmitting unit 202 set the quantity of data to be transmitted when the communication quality of the radio link is preferable to a value larger than the quantity of data to be transmitted when the communication quality of the radio link is very poor. More specifically, for example, when having determined that the effective bandwidth of the radio link is broad (the congestion degree of the base station is low, or the radio quality of the receiving side apparatus 400 is preferable), the transmitting/receiving unit 201 and the after-connection retransmitting unit 202 increase the value of the transmission rate, make the window size larger, and/or increase the growth speed of the window size.

When having determined that the effective bandwidth of the radio link is narrow (the congestion degree of the base station is high, or the radio quality of the receiving side apparatus 400 is poor), the transmitting/receiving unit 201 and the after-connection retransmitting unit 202 decrease the value of the transmission rate, make the window size smaller, and/or reduce the growth speed of the window size. The growth speed of the window size is the quantity of increase (which may be the increase ratio) of the window size when the transmitting side apparatus 220 performs congestion control for gradually increasing the window size in accordance with the elapse of time, the reception of an ACK packet, or the like.

As further another example of the control of the transmission quantity of packets by the transmitting side apparatus 220, the transmitting side apparatus 220 may be configured to store the connection environment information having been acquired by the connection environment acquisition unit 224, and control the transmission of packets on the basis of communication parameters (the transmission rate, the window size, and the like) set in the past. Specifically, for example, the connection environment acquisition unit 224 generates and stores a correspondence table in which connection environment information of the receiving side apparatus 400 and communication parameters applied in the connection environment are associated with each other. Then, the after-connection retransmitting unit 202 selects communication parameters in accordance with the connection environment of the receiving side apparatus 400 on the basis of the correspondence table.

According to the present example embodiment, when the receiving side apparatus 400 is connected to a base station via a radio link, the transmitting side apparatus 220 becomes capable of communicating with the receiving side apparatus 400 at a communication speed suitable for the connection environment of the receiving side apparatus 400. Accordingly, the retransmission can be promptly completed by utilizing the communication network 300 more effectively than the example in the communication system 100 of the first example embodiment.

### Specific Examples

Next, a specific example of the operation of the first example embodiment of the present invention will be described. In this example, it is assumed that a receiving side apparatus and a transmitting side apparatus are communication apparatuses each including a central processing unit, a memory, a storage device, and a communication network connection function unit.

It is assumed that the receiving side apparatus is connected to a communication network in which a network management apparatus is installed; the transmitting side apparatus, the receiving side apparatus, and the network management apparatus are capable of communicating with one another in accordance with a communication environment of the receiving side apparatus; and the transmitting side apparatus is sequentially transmitting each of packets to the receiving side apparatus.

Now, it is assumed that, when the receiving side apparatus has received a 100th packet and has transmitted an acknowledgment packet, because of the deterioration of the communication environment of the receiving side apparatus, the radio link between the receiving side apparatus and the communication network has been disconnected and the communication therebetween has been disabled. Further, it is assumed that, upon transmission of a 110th packet, the transmitting side apparatus has become incapable of transmitting any new packet because of no reception of the acknowledgment packet from the receiving side apparatus and the limited transmission quantity (the limited transmission quantity in accordance with the window size in the TCP). And also, it is assumed that, thereafter, the communication environment between the receiving side apparatus and the communication network has been improved by the movement of the receiving side apparatus, or the like.

With the improvement of the communication environment, the receiving side apparatus transmits a connection request to the network management apparatus. In response to the transmission of the connection request from the receiving side apparatus, the network management apparatus transmits a connection notification to the transmitting side apparatus. The network management apparatus generates the connection notification including “1. 1. 1. 1” that is the IP address of the receiving side apparatus, and transmits the generated connection notification to the transmitting side apparatus. The transmitting side apparatus having received the connection notification refers to the management table, and thereby searches for and specifies communication whose transmission destination corresponds to the IP address “1. 1. 1. 1” included in the connection notification having been received. Moreover, for example, the transmitting side apparatus specifies that, in the specified communication, although acknowledgments for the transmissions of packets up to the 100th packet have been received, any acknowledgment for the transmissions of a 101st packet and following packets is not yet received. Thus, the transmitting side apparatus promptly starts the retransmission from the 101st packet.

A specific example of the operation of the example embodiment of the present invention in the case where the communication network is an LTE network will be described herein below.

It is assumed that a transmitting side apparatus (for example, a server) is transmitting packets to a receiving side apparatus (UE: User Equipment). Further, it is assumed that, after the receiving side apparatus has received packets up to a 100th packet and has transmitted an acknowledgment (ACK) packet, the quality of a radio link with the communication network has been deteriorated, and a radio link failure (RLF) has occurred.

Because of the occurrence of the radio link failure, the receiving side apparatus becomes incapable of receiving a 101st packet and following packets, and transmitting any acknowledgment. Further, it is assumed that the transmitting side apparatus becomes incapable of receiving any acknowledgment from the receiving side apparatus, and upon transmission of packets up to a 110th packet, no space exists in a TCP window, and thus, the transmitting side apparatus has become incapable of transmitting any new packets.

The packets from the 101st packet up to the 110th packet that have been transmitted from the transmitting side apparatus are not transmitted to the receiving side apparatus and are retained (buffered) by a base station (referred to as a base station A in the present example) to which the receiving side apparatus has been connected until immediately before the occurrence of the radio link failure.

It is assumed that, because of a reason in which the receiving side apparatus has moved at the time of the occurrence of the radio link failure, or the like, after the occurrence of the radio link failure, the receiving side apparatus has transmitted a connection request for an establishment of a radio link to a base station B different from the base station A. In such a case, first, the receiving side apparatus, for which the radio link failure has occurred, transmits a re-connection request (RRC Connection Reestablishment Request) on the basis of an LTE specification. In the case where, however, like the present example, the receiving side apparatus attempts to change a connection-destination base station without going through a normal handover procedure, UE Context information (information indicating authentication information and the like of the receiving side apparatus) retained by the base station A is not transferred to the base station B. As a result, the base station B cannot accept the re-connection request from the receiving side apparatus, and rejects the re-connection request having been transmitted by the receiving side apparatus.

The receiving side apparatus, for which the re-connection request is rejected, subsequently transmits a connection request (RRC Connection Request). The base station B having received the connection request (RRC Connection Request) newly performs an authentication processing and the like with the receiving side apparatus, and establishes a radio link (RRC Connection) with the receiving side apparatus.

Since, however, the packets buffered by the base station A (the packets from the 101st packet up to the 110th packet) are not transferred to the base station B, as a result, these packets are lost. Thus, upon establishment of a radio link (RRC Connection) with the receiving side apparatus, the base station B transmits a connection notification to the transmitting side apparatus. Specifically, the base station B transmits a connection notification to the transmitting side apparatus after having transmitted an RRC Connection Setup message after the reception of the RRC Connection Request message having been transmitted by the receiving side apparatus; after having received an RRC Connection Setup Complete message having been transmitted by the receiving side apparatus; or the like. The transmitting side apparatus having received the connection notification having been transmitted by the base station B promptly retransmits the packets from the 101st packet up to the 110th packet, which are lost packets, to the receiving side apparatus.

Next, a specific example of the operation of the second example embodiment of the present invention will be described. The network management apparatus having received a connection request having been transmitted by a receiving side apparatus acquires the number of connected terminals of a base station to which the receiving side apparatus is connecting. The network management apparatus generates, for example, a connection notification including “1. 1. 1. 1” that is the IP address of the receiving side apparatus and “1” that is the number of connected terminals of the base station, and transmits the generated connection notification to a transmitting side apparatus.

When having acquired the number of connected terminals “1”, which is included in the connection notification having been received from the network management apparatus, the transmitting side apparatus determines that the transmission rate may be increased, and promptly transmits the packets from the 101st packet up to the 110th packet, for which any acknowledgment is not yet received.

In the case where the number of connected terminals, which is included in the connection notification having been received from the network management apparatus, is “10”, the transmitting side apparatus promptly transmits the packets from the 101st packet up to the 110th packet, for which any acknowledgment is not yet received, at a lower speed (with a smaller traffic flow quantity) than the case where the number of connected terminals is “1”. That is, it is estimated that, when the number of connected terminals of the base station is large, the congestion degree of the base station is high and the effective bandwidth of the base station is narrow, and thus, the packets are transmitted at a lower speed than a case where the number of connected terminals of the base station is small.

According to the above specific examples, the aforementioned advantageous effect by the first example embodiment and advantageous effect by the second example embodiment can be each brought about.

### Example Embodiment 3

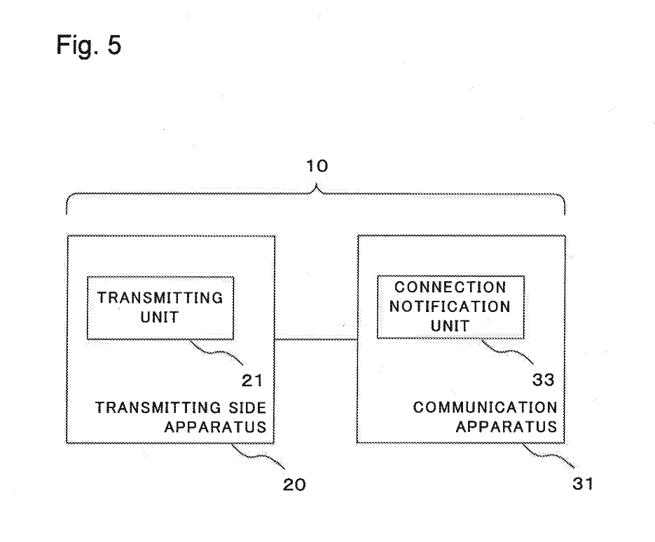

Next, a third example embodiment of the present invention will be described with reference to one of the drawings. FIG. 5 is a block diagram illustrating an example of the configuration of a communication system 10 of the third example embodiment of the present invention. As shown in FIG. 5, the communication system 10 of the third example embodiment of the present invention includes a transmitting side apparatus 20 and a communication apparatus 31.

The transmitting side apparatus 20 corresponds to the transmitting side apparatus 200 shown in FIG. 1 and the transmitting side apparatus 220 shown in FIG. 4. The communications apparatus 31 corresponds to the network management apparatus 310 shown in FIG. 1 and the network management apparatus 320 shown in FIG. 4.

The transmitting side apparatus 20 includes a transmitting unit 21, and this transmitting unit 21 transmits data to a receiving side apparatus (corresponding to the receiving side apparatus 400 shown in FIGS. 1 and 4). The transmitting unit 21 corresponds to the transmitting/receiving unit 201 shown in FIGS. 1 and 4.

The communications apparatus 31 is installed on a communication network to which the transmitting side apparatus 20 and the receiving side apparatus are capable of connecting; includes a connection notification unit 33; and transmits/receives data at a position between the transmitting side apparatus 20 and the receiving side apparatus. The communication network corresponds to the communication network 300 shown in FIGS. 1 and 4. The connection notification unit 33 corresponds to the connection notification unit 311 shown in FIG. 1 and the connection notification unit 321 shown in FIG. 4.

Then, when having received a connection request from the receiving side apparatus, the connection notification unit 33 transmits a connection notification to the transmitting side apparatus 20.

When the transmitting side apparatus 20 has received the connection notification, the transmission unit 21 transmits data.

According to the present example embodiment, when the radio link between the receiving side apparatus and a base station has entered a communicable state, the communication between the transmitting side apparatus and the receiving side apparatus can be promptly resumed and packets can be appropriately transmitted/received.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2015-138638, filed on Jul. 10, 2015, the disclosure of which is incorporated herein in its entirety by reference.

### REFERENCE SIGNS LIST

10, 100, and 120 communication system

20, 200, and 220 transmitting side apparatus

21 transmitting unit

31 communication apparatus

33 connection notification unit

201 transmitting/receiving unit

202 after-connection retransmitting unit

224 connection environment acquisition unit

300 communication network

310, and 320 network management apparatus

311 and 321 connection notification unit

400 receiving side apparatus

What is claimed is:

1. A communication system comprising:
a transmitting side apparatus including transmitting unit configured to transmit data to a receiving side apparatus; and
a communication apparatus installed in a network to which the transmitting side apparatus and the receiving side apparatus are connectable,
wherein the communication apparatus includes connection notifying unit configured to, upon reception of a connection request from the receiving side apparatus, transmit a connection notification to the transmitting side apparatus, and
wherein upon reception of the connection notification, the transmitting side apparatus allows the transmitting unit to transmit data.

2. The communication system according to claim 1, wherein the connection notification includes at least information sufficient for, in the transmitting side apparatus, identifying the receiving side apparatus that is a request source of the connection request, and upon reception of the connection notification, the transmitting unit identifies the receiving side apparatus, which is the request source of the connection request, and transmits data to the receiving side apparatus that is identified.

3. The communication system according to claim 2, wherein the data, which is transmitted by the transmitting unit upon reception of the connection notification, includes data which is already transmitted to the receiving side apparatus and for which no acknowledgment is received from the receiving side apparatus.

4. The communication system according to claim 1, wherein the connection request is a connection request that is transmitted by the receiving side apparatus when, after a disconnection of at least a portion of a communication line between the receiving side apparatus and the transmitting side apparatus, the communication line has been connected again.

5. The communication system according to claim 1,
wherein the connection notifying unit receives connection environment information indicating a communication quality between the receiving side apparatus and the communication network from the receiving side apparatus, and transmits the connection notification including the connection environment information to the receiving side apparatus, and
wherein the transmitting unit controls a transmission quantity of data that is to be transmitted upon reception of the connection notification, depending on the communication quality, the communication quality being indicated by the connection environment information.

6. The communication system according to claim 1, wherein the receiving side apparatus is connected to the communication network via a radio link, and the connection request is a request for an establishment of the radio link.

7. The communication system according to claim 1, further comprising the receiving side apparatus.

8. A communication method comprising:
upon reception of a connection request from a receiving side apparatus configured to receive data transmitted by a transmitting side apparatus, transmitting, to the transmitting side apparatus, a connection notification for allowing the transmitting side apparatus to transmit data.

9. A non-volatile storage medium having a communication program stored thereon for allowing a computer to execute processing comprising:
a connection notification processing configured to, upon reception of a connection request from a receiving side apparatus configured to receive data transmitted by a transmitting side apparatus, transmit, to the transmitting side apparatus, a connection notification for allowing the transmitting side apparatus to transmit data.

10. A non-volatile storage medium having a communication program stored thereon for allowing a computer to execute processing comprising:
an acknowledgment relay processing configured to transmit an acknowledgment that is transmitted by a receiving side apparatus, the receiving side apparatus being configured to receive data transmitted by a transmitting side apparatus, the acknowledgement being an acknowledgment for the reception of the data by the receiving side apparatus; and
a connection notification processing configured to, upon reception of a connection request from the receiving side apparatus, transmit, to the transmitting side apparatus, a connection notification for allowing already transmitted data to be retransmitted based on the acknowledgment received.
